(19) United States
(12) Patent Application Publication
(10) Pub. No.: US 2026/0038734 A1
(43) Pub. Date: Feb. 5, 2026

(54) POWER ADAPTER

(71) Applicant: Delta Electronics, Inc., Taoyuan City (TW)

(72) Inventors: Yi Chih HSU, Taoyuan City (TW); Jen Chieh TSAI, Taoyuan City (TW); Jyun-Ming LIN, Taoyuan City (TW)

(21) Appl. No.: 19/185,423

(22) Filed: Apr. 22, 2025

(30) Foreign Application Priority Data
Jul. 30, 2024 (CN) 202411031951.5

(51) Int. Cl. H01F 27/32; H01F 27/40; H01F 30/06; H01F 38/20

(52) U.S. Cl. CPC H01F 27/324; H01F 27/40; H01F 30/06; H01F 38/20

(57) ABSTRACT

A power adapter is provided. The power adapter includes an insulating member, a primary-side coil circuit, and a secondary-side coil circuit. The insulating member has a fixing portion and a supporting portion on a first side. The insulating member further has a positioning portion on a second side. The second side is opposite the first side. The first side and the second side are two opposite sides in a first direction. The primary-side coil circuit has a fixed surface and a supported surface. The fixing portion is affixed to the fixed surface. The supporting part supports the supported surface. The secondary-side coil circuit has a main surface with a positioning hole. The positioning portion is inserted into the positioning hole.

### CROSS REFERENCE TO RELATED APPLICATIONS

This application claims the benefit of China patent application No. 202411031951.5, filed Jul. 30, 2024, the entirety of which is incorporated by reference herein.

### BACKGROUND OF THE INVENTION

### Field of the Invention

The present invention relates to a power adapter, and, in particular, it relates to a power adapter having an insulating member to insulate the primary-side coil circuit from the secondary-side coil circuit.

### Description of the Related Art

Conventional power adapters usually comprise a primary-side coil circuit and a secondary-side coil circuit coupled to each other. The distance between electronic components in coil circuits must become closer in order to meet the increasing demand for power adapters that are smaller and take up less space. To prevent adjacent coil circuits or electronic components from short-circuiting or discharging sparks, the insulation requirements also increase.

To enhance insulation between coil circuits or electronic components in a power adapter, insulating sheets may be provided during assembly of the power adapter. For example, insulating sheets may be installed between the assembled primary-side and secondary-side coil circuits. However, the additional installation steps may increase the time it takes to assemble the power adapter.

Moreover, the insulating sheets between the coil circuits may become loose or misplaced, meaning that the insulation requirements between the coil circuits or electronic components may not be met. For example, the overall insulation of the secondary-side coil circuit may not be met. Therefore, it has become a challenge to reduce assembly time and improve electrical insulation in the power adapters.

### BRIEF SUMMARY OF THE INVENTION

An embodiment of the present invention provides a power adapter that includes an insulating member, a primary-side coil circuit, and a secondary-side coil circuit. The insulating member has a fixing portion, a supporting portion and a positioning portion. The fixing portion and the supporting portion are located on the first side of the insulating member, and the positioning portion is located on the second side of the insulating member. The first and second sides are opposite sides of the insulating member along the first direction.

The primary-side coil circuit has a fixed surface and a supported surface, wherein the fixing portion is affixed to the fixed surface, and the supported surface is supported by the supporting portion.

The secondary-side coil circuit has a main surface that forms a positioning hole, wherein the positioning portion is inserted in the positioning hole.

In some embodiments, the insulating member further has an opening portion located closer to the second side than the supporting portion. The opening portion faces a second direction. The second direction is perpendicular to the first direction.

In some embodiments, the fixing portion and the supporting portion are not aligned with each other in the first direction.

In some embodiments, the supporting portion has a rib extending in the first direction, a first end surface on the first side, and a second end surface on the second side, wherein the first end surface supports the primary-side coil circuit, the second end surface abuts the secondary-side coil circuit, and the positioning portion extends from the second end surface toward the second side.

In some embodiments, the supported surface of the primary-side coil circuit, the insulating member, and the main surface of the secondary-side coil circuit surround an accommodation space, and the primary-side coil circuit further has a connecting portion received in the accommodation space.

In some embodiments, the insulating member further has an opening portion facing the connecting portion.

In some embodiments, the connecting portion extends from the supported surface toward the second side for receiving an external component, and the external component is inserted into the connecting portion in a second direction that is perpendicular to the first direction.

In some embodiments, the insulating member further has a guide portion for guiding the position of the primary-side coil circuit.

In some embodiments, the guide portion has a guide rail, and a part of the primary-side coil circuit is inserted into and slides along the guide rail.

In some embodiments, the guide portion has a guide rib, and the primary-side coil circuit further has a connecting portion abutting the guide rib.

### BRIEF DESCRIPTION OF THE DRAWINGS

The present invention can be more fully understood by reading the subsequent detailed description and examples with references made to the accompanying drawings, wherein:

FIG. 1 is a perspective view of the power adapter 100 in accordance with the first embodiment of the invention.

FIG. 2 is a perspective diagram showing the insulating member 10 of the power adapter 100 in accordance with the first embodiment of the invention.

FIG. 3 is another perspective diagram showing the insulating member 10 of the power adapter 100 in accordance with the first embodiment of the invention.

FIG. 4 is a front view of the insulating member 10 of the power adapter 100 in accordance with the first embodiment of the invention.

FIG. 5 is a perspective diagram showing the insulating member 10 and the primary-side coil circuit 20 of the power adapter 100 affixed to each other, in accordance with the first embodiment of the invention.

FIG. 6 is a perspective view of the power adapter 100′ in accordance with the second embodiment of the invention.

FIG. 7 is a perspective diagram showing the insulating member 10′ of the power adapter 100′ in accordance with the second embodiment of the invention.

FIG. 8 is a front view of the insulating member 10′ of the power adapter 100′ in accordance with the second embodiment of the invention.

FIG. 9 is a perspective diagram showing the insulating member 10′ and the primary-side coil circuit 20 of the power adapter 100′ affixed to each other, in accordance with the second embodiment of the invention.

FIG. 10 is a front view of the insulating member 10′ and the primary-side coil circuit 20 of the power adapter 100′ affixed to each other, in accordance with the second embodiment of the invention.

### DETAILED DESCRIPTION OF THE INVENTION

The making and using of the embodiments of the power adapter are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

### First Embodiment

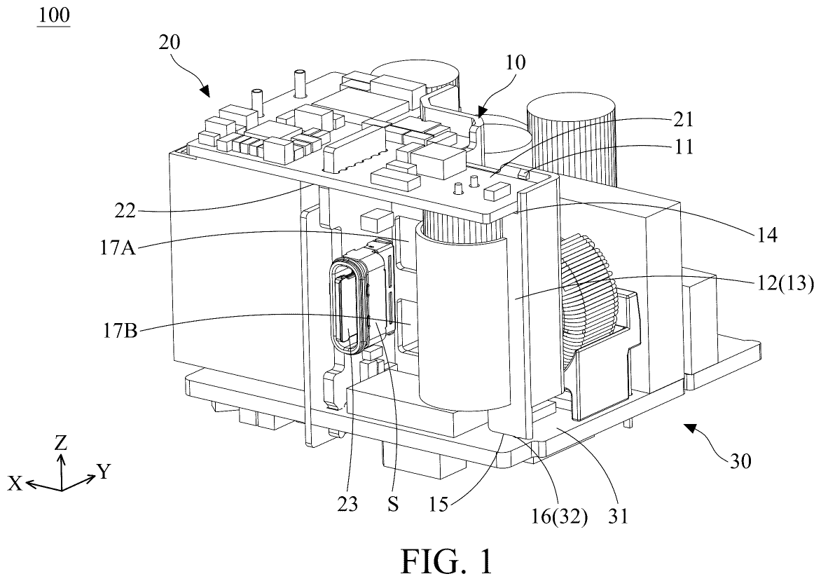

The configuration of this embodiment will be described with reference to FIGS. 1 to 5. FIG. 1 is a perspective view of the power adapter 100 of this embodiment. In this embodiment, the power adapter 100 includes an insulating member 10, a primary-side coil circuit 20, and a secondary-side coil circuit 30.

The insulating member 10 primarily has a fixing portion 11, a supporting portion 12, and a positioning portion 16. The primary-side coil circuit 20 has a fixed surface 21 and a supported surface 22. The secondary-side coil circuit 30 has a main surface 31 that forms a positioning hole 32. After assembly of the power adapter 100, as shown in FIG. 1, the fixing portion 11 of the insulating member 10 is affixed to the fixed surface 21 of the primary-side coil circuit 20, the supporting portion 12 of the insulating member 10 supports the supported surface 22 of the primary-side coil circuit 20, and the positioning portion 16 is inserted into the positioning hole 32.

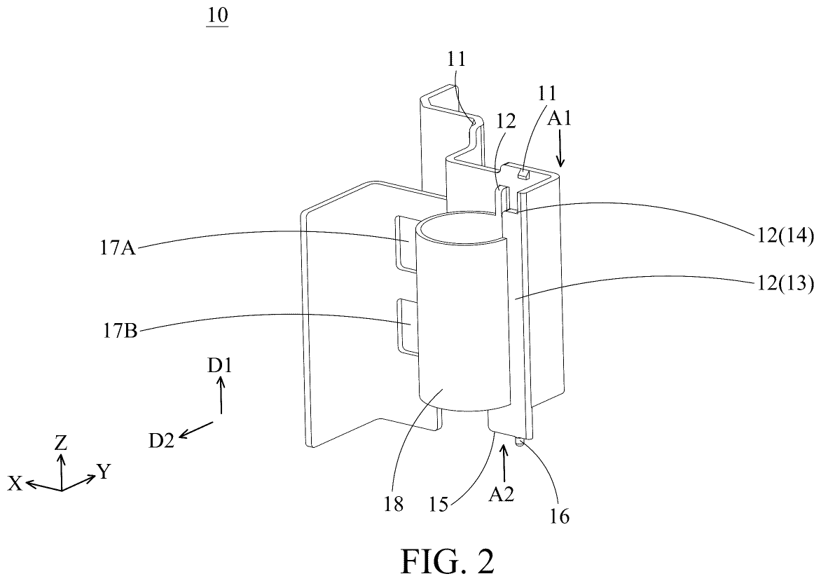

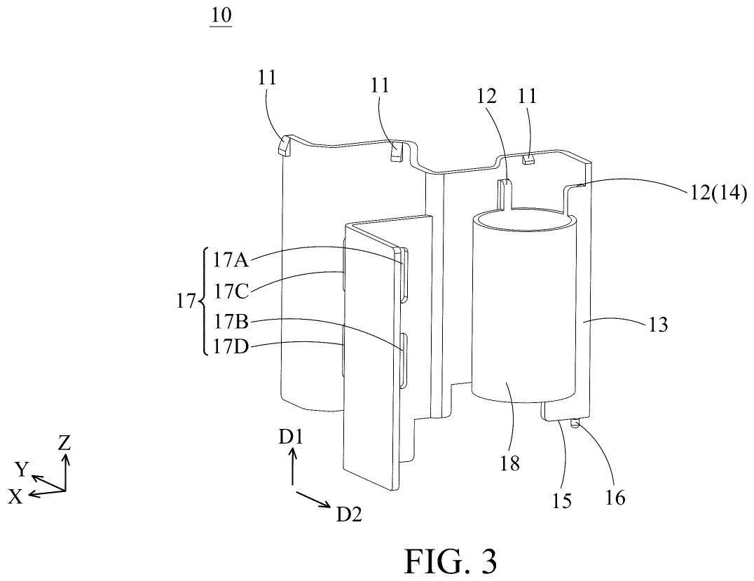

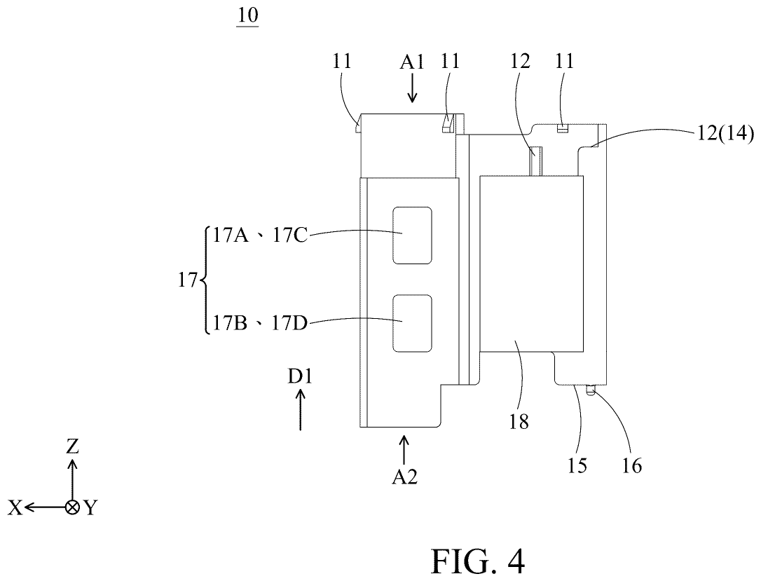

Referring to FIGS. 1 to 4, the detailed structure of the insulating member 10 of this embodiment will be described below. FIG. 2 is a perspective diagram showing the insulating member 10 of the power adapter 100 in this embodiment. FIG. 3 is another perspective diagram showing the insulating member 10 of the power adapter 100 in this embodiment. FIG. 4 is a front view of the insulating member 10 of the power adapter 100 in this embodiment.

First, the fixing portion 11, the supporting portion 12, and the positioning portion 16 of the insulating member 10 are demonstrated. The insulating member 10 has a first side A1 and a second side A2, wherein the first and second sides A1 and A2 are opposite sides of the insulating member 10 in the first direction D1 (e.g. the Z direction). The fixing portion 11 and the supporting portion 12 are located on the first side A1 of the insulating member 10, and the positioning portion 16 is located on the second side A2 of the insulating member 10.

The fixing portion 11 includes three protrusions that protrude from the surface of the insulating member 10. However, as long as the fixing portion 11 can contact the fixed surface 21 to fix the primary-side coil circuit 20, the shape, number, position, etc. are not particularly limited. In addition, the supporting portion 12 includes two protrusions that protrude from the surface of the insulating member 10. However, as long as the supported surface 22 can be supported by the supporting portion 12, there are no particular restrictions on the shape, number, position, etc. of the supporting portion 12.

In this embodiment, the supporting portion 12 forms a rib 13 extending in the first direction D1. The rib 13 has a first end surface 14 on the first side A1 and a second end surface 15 on the second side A2. The first end surface 14 abuts the supported surface 22 of the primary-side coil circuit 20, and the second end surface 15 is in contact with the main surface 31 of the secondary-side coil circuit 30. The positioning portion 16 extends from the second end surface 15 toward the second side A2. There are no particular restrictions on the shape, number, position, etc. of the positioning portion 16 as long as it can be positioned well on the secondary-side coil circuit 30. In some embodiments, instead of extending from the second end surface 15 of the rib 13, the positioning portion 16 may directly extend from other end surfaces on the second side A2 of the insulating member 10.

Moreover, as can be seen from FIG. 4, the fixing portion 11 and the supporting portion 12 are not aligned with each other in the first direction D1 (or Z direction).

In this embodiment, the insulating member 10 further has an opening portion 17 located closer to the second side A2 than the supporting portion 12. Specifically, the opening portion 17 faces toward a second direction D2 (e.g. −Y direction) that is perpendicular to the first direction D1.

Though the insulating member 10 may have better insulation property without forming the opening portion 17, the opening portion 17 is still needed on the insulating member 10 to enhance the waterproof performance of the power adapter 100. From this point of view, the openings of the opening portion 17 are preferably formed at a position where insulation requirements are low. As shown in FIGS. 3 and 4, the opening portion 17 of the insulating member 10 in this embodiment includes four openings 17A, 17B, 17C, and 17D. The two openings 17A, 17B are formed on one side of the insulating member 10, and the other two openings 17C, 17D are formed on the other side of the insulating member 10.

In the front view of FIG. 4, the sizes and positions of the four openings 17A, 17B, 17C, and 17D correspond to each other. Specifically, the sizes and the positions of the openings 17A and 17C correspond to each other. Similarly, the sizes and the positions of the openings 17B and 17C correspond to each other. It should be noted that the shape, number, position, etc. of the opening portion 17 are not particularly limited as long as it can allow, for example, waterproof glue to flow to a specific position and meet the insulation requirements of the power adapter 100.

In this embodiment, the insulating member 10 further has a hollow barrel portion 18. The barrel portion 18 has a bottom and is connected to the supporting portion 12 and the rib 13. Therefore, the structural strength of the supporting portion 12 and the rib 13 can be improved. In addition, some components of the primary-side coil circuit 20 can be accommodated in the barrel portion 18, thus providing better insulating protection for the components. However, when the insulation requirements are low, the barrel portion 18 may have a hollow structure without the bottom. In some embodiments, the barrel portion 18 may be omitted from the insulating member 10.

Referring back to FIG. 1, the detailed structure of the primary-side coil circuit 20 in this embodiment will be described below. As shown in FIG. 1, the supported surface 22 of the primary-side coil circuit 20, the insulating member 10, and the main surface 31 of the secondary-side coil circuit 30 surround an accommodation space S. The primary-side coil circuit 20 further has a connecting portion 23 received in the accommodation space S. The connecting portion 23 extends from the supported surface 22 toward the second side A2, and an external component can be inserted into the connecting portion 23 along the second direction D2. Hence, the power adapter 100 can be electrically connected to an external circuit through the connecting portion 23. The connection part 23 may be, for example, a Type-C Universal Serial Bus (USB), but is not limited thereto, and may be other types of connectors.

In this embodiment, the openings of the opening portion 17 face the connecting portion 23. When applying the waterproof glue to the power adapter 100, the glue can flow near the connecting portion 23 to enhance the waterproof performance of the connecting portion 23 and increase the safety of electrical connection with the external circuit.

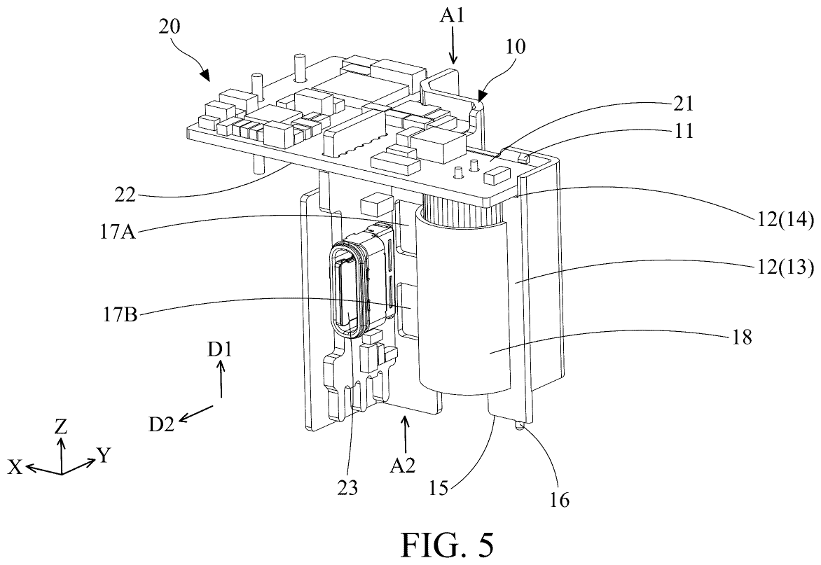

The steps of assembling the power adapter 100 will be described with reference to FIG. 1 and FIG. 5. As shown in FIG. 5, during assembly of the power adapter 100, a part of the primary-side coil circuit 20 is disposed into the barrel portion 18 from the first side A1 of the insulating member 10, and the supported surface 22 is placed on the supporting portion 12. In this state, the fixing portion 11 abuts the fixed surface 21 of the primary-side coil circuit 20, and the primary-side coil circuit 20 is clamped between the fixing portion 11 and the supporting portion 12. Hence, the insulating member 10 and the primary-side coil circuit 20 are affixed to each other without relative displacement between them.

Subsequently, the insulating member 10 and the primary-side coil circuit 20 can be assembled to the secondary-side coil circuit 30. As shown in FIG. 1, the positioning portion 16 is inserted into the positioning hole 32, and the second end surface 15 of the rib 13 is in contact with the main surface 31 of the secondary-side coil circuit 30. Thus, the insulating member 10 and the primary-side coil circuit 20 are affixed to the secondary-side coil circuit 30 without relative displacement between them, and the assembly of the power adapter 100 is accomplished. After that, the glue can be optionally added according to whether there is a need to enhance the waterproof performance of the power adapter 100.

Through the technical features of this embodiment, the primary-side coil circuit 20 can be firstly connected to the insulating member 10, and then the primary-side coil circuit 20, the insulating member 10, and the secondary-side coil circuit 30 can be properly positioned and affixed to each other. Compared with the conventional insulating sheets installed between the assembled primary-side and secondary-side coil circuits, the structure of this embodiment can reduce assembly time of the power adapter 100 and meet the insulation requirement between the coil circuits or the electronic components.

### Second Embodiment

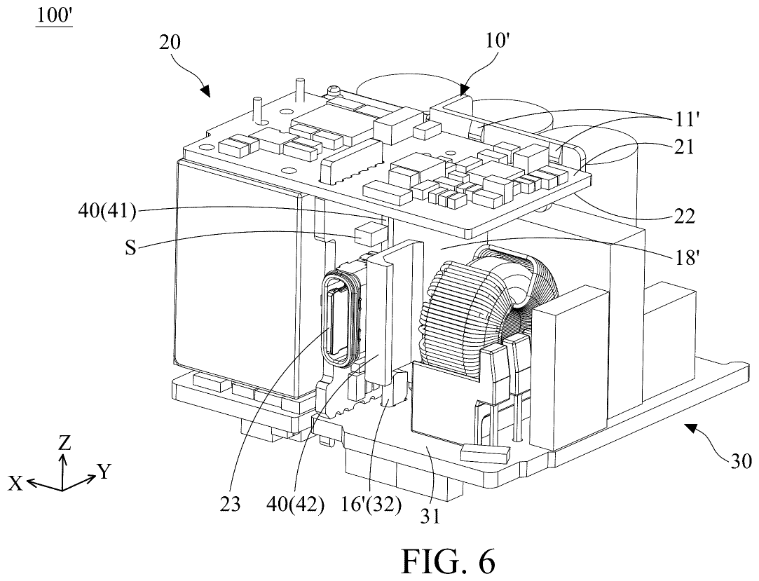

The structure of this embodiment will be described with reference to FIGS. 6 to 10, and the same components as those described above will be described with the same reference numerals. FIG. 6 is a perspective view of the power adapter 100′ of this embodiment. In this embodiment, the power adapter 100′ includes an insulating member 10′, a primary-side coil circuit 20, and a secondary-side coil circuit 30.

The insulating member 10′ has a fixing portion 11′, a supporting portion 12′, and a positioning portion 16′. The primary-side coil circuit 20 has a fixed surface 21 and a supported surface 22. The secondary-side coil circuit 30 has a main surface 31 that forms a positioning hole 32. When the power adapter 100′ is assembled as shown in FIG. 6, the fixing portion 11′ of the insulating member 10′ is affixed to the fixed surface 21 of the primary-side coil circuit 20, the supported surface 22 of the primary-side coil circuit 20 is supported by the supporting portion 12 of the insulating member 10′, and the positioning portion 16′ is inserted into the positioning hole 32 of the secondary-side coil circuit 30.

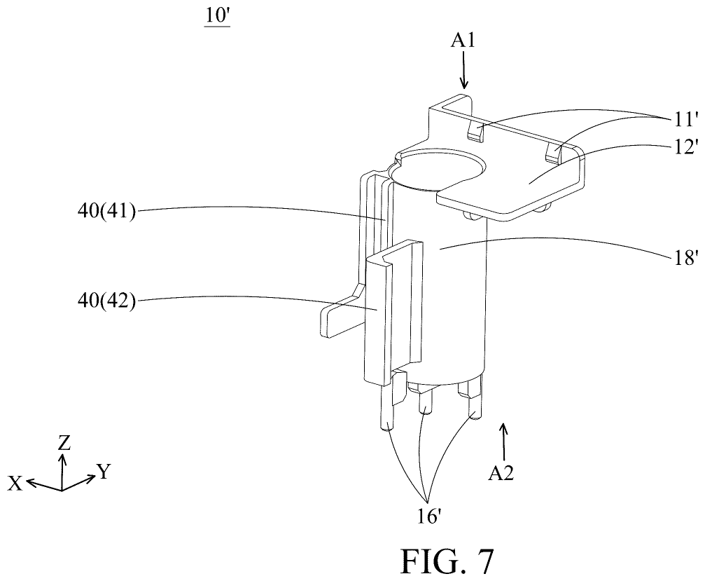

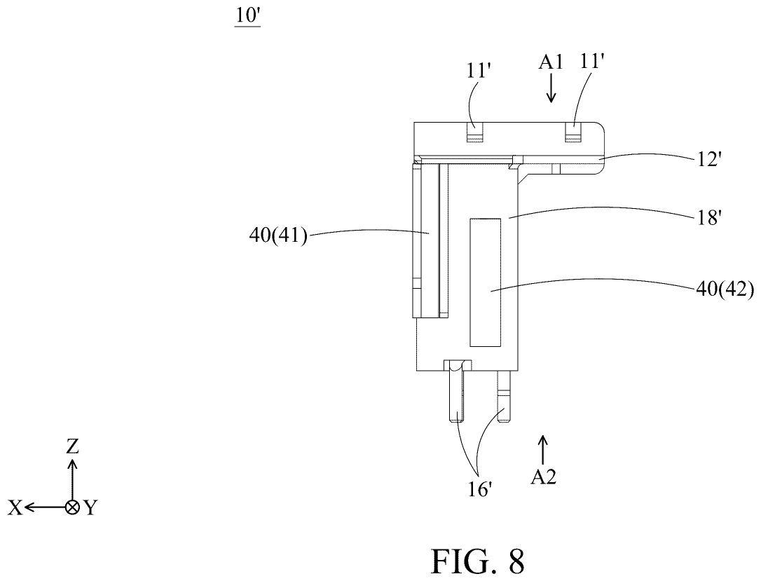

FIG. 7 is a perspective diagram showing the insulating member 10′ of the power adapter 100′ in this embodiment. FIG. 8 is a front view of the insulating member 10′ of the power adapter 100′.

The fixing portion 11′, the supporting portion 12′, the positioning portions 16′, and the barrel portion 18′ will be described below, and the same parts as in the first embodiment will not be described again. This embodiment is different from the first embodiment in that the number of the protrusions on the fixing portion 11′ is two, and the supporting portion 12′ has a flat structure. Moreover, the number of positioning portions 16′ is three, and the upper edge of the barrel portion 18′ is connected to the flat supporting portion 12′.

In this embodiment, the insulating member 10′ further has a guide portion 40. The guide portion 40 is configured to guide the position of the primary-side coil circuit 20 in the Z direction.

The guide portion 40 includes a guide rail 41 and a guide rib 42. As shown in FIGS. 7 and 8, the guide rail 41 is connected to the peripheral of the barrel portion 18′ and extends in the −Z direction from the upper edge of the barrel portion 18′ along the outer surface of the barrel portion 18′. The guide rib 42 is spaced apart from the guide rail 41 in the X direction and has a flat plate-shaped structure facing the guide rail 41.

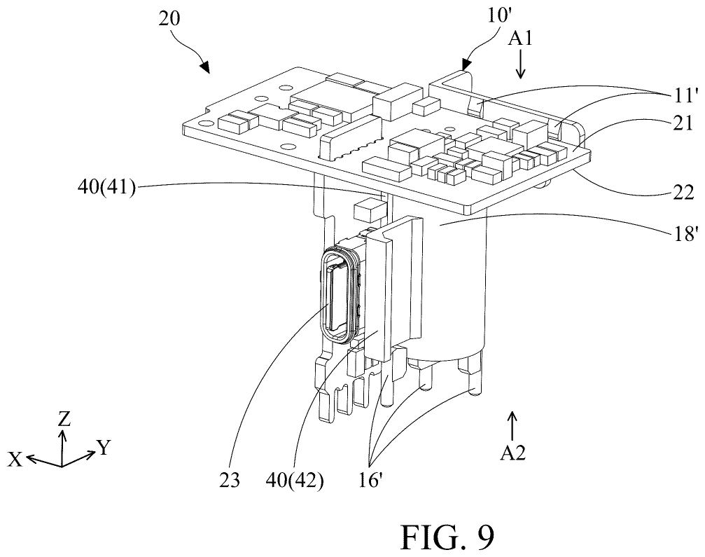

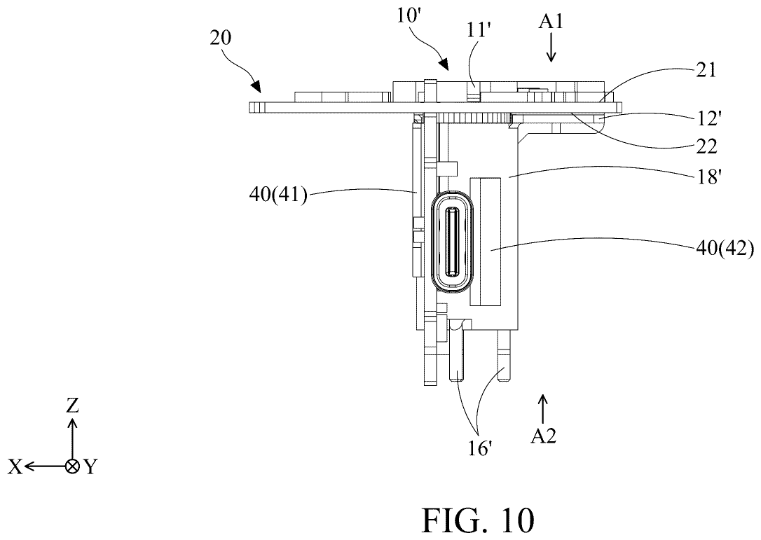

The assembly steps of the power adapter 100′ will be described below with reference to FIGS. 6, 9, and 10. As shown in FIGS. 9 and 10, during assembly of the power adapter 100′, a part of the primary-side coil circuit 20 is disposed into the barrel portion 18′ from the first side A1 of the insulating member 10′, and another part of the primary-side coil circuit 20 (e.g. the circuit board) is inserted into and slides along the guide rail 41. When the primary-side coil circuit 20 slides along the guide rail 41 to a predetermined position, the guide rib 42 abuts the connection portion 23 of the primary-side coil circuit 20 so that the connection portion 23 can be accurately guided and positioned in the X direction.

With the primary-side coil circuit 20 sliding toward the second side A2 along the guide rail 41, the supported surface 22 can be placed on the supporting portion 12′. In this state, the fixing portion 11′ catches the fixed surface 21 of the primary-side coil circuit 20, and the primary-side coil circuit 20 is clamped between the fixing portion 11′ and the supporting portion 12. Hence, the insulating member 10′ and the primary-side coil circuit 20 are affixed to each other without relative displacement between them.

Subsequently, the insulating member 10′ and the primary-side coil circuit 20 are assembled to the secondary-side coil circuit 30. As shown in FIG. 6, the positioning portion 16′is inserted into the positioning hole 32, and the lower end surface of the insulating member 10′ is in contact with the main surface 31 of the secondary-side coil circuit 30. Thus, the insulating member 10′ and the primary-side coil circuit 20 are affixed to the secondary-side coil circuit 30 without relative displacement between them, and the assembly of the power adapter 100′ is accomplished.

Through the technical features of this embodiment, the primary-side coil circuit 20 can be firmly connected to the insulating member 10′, and then the primary-side coil circuit 20, the insulating member 10′, and the secondary-side coil circuit 30 can be properly positioned and affixed to each other. Compared with the conventional insulating sheets which are installed between the assembled primary-side and secondary-side coil circuits, the structure of this embodiment can reduce assembly time of the power adapter 100 and meet the insulation requirement between the coil circuits or the electronic components.

In addition, compared with the first embodiment, the primary-side coil circuit 20 in this embodiment can be guided to correct position rapidly and accurately through the guide rail 41, and the connection portion 23 can be accurately positioned through the guide ribs 42. Therefore, the assembly time of the power adapter 100′ can be reduced, and the insulating member 10′ can provide effective and reliable insulation performance at the correct position.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A transformer structure, comprising:
A power adapter, comprising:
an insulating member, having a fixing portion, a supporting portion and a positioning portion, wherein the fixing portion and the supporting portion are located on a first side of the insulating member, and the positioning portion is located on a second side of the insulating member, wherein the first and second sides are opposite sides of the insulating member along a first direction;
a primary-side coil circuit, having a fixed surface and a supported surface, wherein the fixing portion is affixed to the fixed surface, and the supported surface is supported by the supporting portion; and
a secondary-side coil circuit, having a main surface that forms a positioning hole, wherein the positioning portion is inserted in the positioning hole.

2. The power adapter as claimed in claim 1, wherein the insulating member further has an opening portion located closer to the second side than the supporting portion and faces a second direction that is perpendicular to the first direction.

3. The power adapter as claimed in claim 1, wherein the fixing portion and the supporting portion are not aligned with each other in the first direction.

4. The power adapter as claimed in claim 1, wherein the supporting portion has a rib extending in the first direction, a first end surface on the first side, and a second end surface on the second side, wherein the first end surface supports the primary-side coil circuit, the second end surface abuts the secondary-side coil circuit, and the positioning portion extends from the second end surface toward the second side.

5. The power adapter as claimed in claim 1, wherein the supported surface of the primary-side coil circuit, the insulating member, and the main surface of the secondary-side coil circuit surround an accommodation space, and the primary-side coil circuit further has a connecting portion received in the accommodation space.

6. The power adapter as claimed in claim 5, wherein the insulating member further has an opening portion facing the connecting portion.

7. The power adapter as claimed in claim 5, wherein the connecting portion extends from the supported surface toward the second side for receiving an external component, and the external component is inserted into the connecting portion in a second direction that is perpendicular to the first direction.

8. The power adapter as claimed in claim 1, wherein the insulating member further has a guide portion for guiding the position of the primary-side coil circuit.

9. The power adapter as claimed in claim 8, wherein the guide portion has a guide rail, and a part of the primary-side coil circuit is inserted into and slides along the guide rail.

10. The power adapter as claimed in claim 8, wherein the guide portion has a guide rib, and the primary-side coil circuit further has a connecting portion abutting the guide rib.
